(19) United States
(12) Patent Application Publication
(10) Pub. No.: US 2025/0031622 A1
(43) Pub. Date: Jan. 30, 2025

(54) AUTONOMOUSLY GUIDED, CONTINUOUS MOVEMENT HARVESTER

(71) Applicants: Brian Andersen, Yuba City, CA (US); Alan Cooper Isaacson, Yuba City, CA (US); Tyler Justice Hill, Yuba City, CA (US); Ryan Patrick Emory, Yuba City, CA (US)

(72) Inventors: Brian Andersen, Yuba City, CA (US); Alan Cooper Isaacson, Yuba City, CA (US); Tyler Justice Hill, Yuba City, CA (US); Ryan Patrick Emory, Yuba City, CA (US)

(21) Appl. No.: 18/787,115

(22) Filed: Jul. 29, 2024

Related U.S. Application Data
(60) Provisional application No. 63/515,990, filed on Jul. 27, 2023.

(51) Int. Cl. A01D 46/26

(52) U.S. Cl. CPC A01D 46/26

(57) ABSTRACT

A shaker mechanism for an agricultural harvester. The shaker mechanism adapted to shake a crop while the agricultural harvester is moving, wherein the shaker mechanism is operatively associated with the agricultural harvester so that the shaker mechanism is movable at zero velocity relative to the crop being shook while the agricultural harvester continuously moves at a non-zero velocity.

### CROSS-REFERENCE TO RELATED APPLICATION

This application claims the benefit of priority of U.S. provisional application No. 63/515,990, filed Jul. 27, 2023, the contents of which are herein incorporated by reference.

### BACKGROUND OF THE INVENTION

The present invention relates to agricultural tree harvest vehicles (“harvesters”) and, more particularly, an agricultural harvester having a shaker head operatively associated thereto so that the shaker head is independently movable relative the agricultural harvester so that shaker head moves at a relative velocity of zero with respect to the tree it is harvesting.

Harvesting of fruit trees, which includes nuts, is typically initiated using equipment to shake the fruit off the tree, which is then gathered for subsequent processing needed prior to delivery to market.

When the harvest of a particular orchard crop occurs, the specific crops on each of the orchard's trees become ripe at about the same time. Since orchards typically have thousands of trees, the harvest is a time-sensitive and time-consuming process which must be completed quickly while the crop is optimally ripe, and it is therefore advantageous to create systems that complete the harvesting operations as quickly as possible. The conventional solution for rapidly harvesting tree crops includes a vehicle called a mechanized tree harvester. The mechanized tree harvester has a shaker head, which through conventional electro-hydraulic control system, engage and shake nut and fruit trees to cause the crop of nuts or fruit to drop off the tree. Such mechanized tree harvesters generally are driven to a location proximate to a tree to be harvested, and decisively, the mechanized tree harvester comes to a complete stop adjacent to the tree to afford the shaker head attached to the mechanized tree harvester time to extend laterally toward, carefully engage, sufficiently shake, and then disengage from the tree. Only after disengagement is the harvester allowed to move forward to the next tree and repeat this start-and-stop process hundreds of times in one day. The shaker head generally includes movable clamp arms with pads that clamp the tree and a motor that powers the shaking process, but the shaker head is movable only in a lateral direction, toward the target tree, orthogonal to the path of the harvester.

The operation of the mechanized tree harvester requires skill and stamina, due to repeated starting and stopping of the vehicle adjacent to each tree, laterally extending the clamping arm to a proper distance, and shaking each tree for a desired duration. To relieve the operator of some of this laborious operation, partial automation systems that use sensors and controls on tree harvesters have been developed. However, no current system enables a mechanized tree harvester to continuously traverse an orchard to shake-harvest the crop without stopping the mechanized tree harvester, since even autonomously controlled mechanized tree harvesters need to stop adjacent each tree to enable the conventional shaking process.

As can be seen, there is a need for an agricultural tree harvest vehicle having a shaker head carriage-mounted on a trolly system so that the shaker head is independently movable along the path of trees in a direction opposite of the path of the harvest vehicle so that the shaker head can establish a relative velocity vis-à-vis a tree it is actively harvesting. As a result, the shaker head can carefully engage, sufficient shake, and disengage each tree all while the underlying harvester is continuously moving through the orchard. The harvest vehicle is outfitted with a machine control system enabling autonomous navigation through the orchard, thereby improving efficiency through avoiding hinderances in unmanned operation, and thus increasing the number of trees shook per minute as well as reducing cost through eliminated need for a dedicated operator.

These and other features, aspects and advantages of the present invention will become better understood with reference to the following drawings, description and claims.

### SUMMARY OF THE INVENTION

The shaker head is movable along a shaker path adjacent to the path of the harvester so that the shaker head can harvest trees along the shaker path without slowing down or governing the continuous movement of the harvester.

In one aspect of the present invention, a shaker mechanism for an agricultural harvester is configured to shake a crop, wherein the shaker mechanism is operatively associated with the agricultural harvester so that the shaker mechanism is movable at zero velocity relative to the crop being shook while the agricultural harvester continuously moves at a non-zero velocity.

In another aspect of the present invention, the shaker mechanism further includes wherein the shaker head is movable at said zero velocity while the agricultural harvester is moving at the non-zero velocity for at least five feet, wherein the shaker mechanism comprises a carriage body slidable along the linear track system, wherein the shaker mechanism further comprises a leading clamp arm and a trailing clamp arm, each clamp arm independently pivotably relative to the carriage body to move between a disengaged position and an engaged position that places the clamp arm in a path of the crop, wherein the shaker mechanism, immediately before shaking the crop, is located at a forwardmost position along the linear track system with the leading clamp arm in the engaged position and the trailing clamp arm in the disengaged position, wherein the shaker mechanism is shaking the crop with both clamp arms in the engaged position, wherein when the shaker mechanism is located at a rearmost position along the linear track system the leading clamp arm is in the disengaged position off the path of the crop, and wherein the linear track system is pivotably connected to the agricultural harvester.

In yet another aspect of the present invention, a system includes an agricultural harvester and a shaker mechanism configured for shaking a crop while the agricultural harvester moves in a first linear direction, wherein the shaker mechanism is operatively associated with the agricultural harvester so that the shaker mechanism is movable in a second linear direction opposite the first linear direction while shaking the crop as the agricultural harvester moves in the first linear direction, wherein the agricultural harvester moves along a harvester path and the shaker mechanism moves along a shaker path defined by a linear track system, wherein the harvester path and the shaker path are parallel.

These and other features, aspects and advantages of the present invention will become better understood with reference to the following drawings, description and claims.

### BRIEF DESCRIPTION OF THE DRAWINGS

FIG. 1A is a top plan view of an exemplary embodiment of the present invention with a trolly system in a transport condition.

FIG. 1B is a top perspective view of an exemplary embodiment of the present invention with the trolly system in the transport condition.

FIG. 1C is a side elevation view of an exemplary embodiment of the present invention with the trolly system in the transport condition.

FIG. 1D is a front elevation view of an exemplary embodiment of the present invention with the trolly system in the transport condition.

FIG. 2A is a top plan view of an exemplary embodiment of the present invention with the trolly system moved to a field condition from the transport condition, with the carriage in a retracted position.

FIG. 2B is a top perspective view of an exemplary embodiment of the present invention with the trolly system in the field condition, with the carriage in the retracted position.

FIG. 2C is a side elevation view of an exemplary embodiment of the present invention with the trolly system in the field condition, with the carriage in the retracted position.

FIG. 2D is a front elevation view of an exemplary embodiment of the present invention with the trolly system in the field condition, with the carriage in the retracted position.

FIG. 3A is a top plan view of an exemplary embodiment of the present invention with the trolly system, in the field condition, with the carriage moved to an extended position from the retracted position, wherein a shaker head is in a pre-engaged condition.

FIG. 3B is a top perspective view of an exemplary embodiment of the present invention with the trolly system in the extended position, wherein the shaker head is in the pre-engaged condition.

FIG. 3C is a side elevation view of an exemplary embodiment of the present invention with the trolly system in the extended position, wherein the shaker head is in the pre-engaged condition.

FIG. 3D is a front elevation view of an exemplary embodiment of the present invention with the trolly system in the extended position, wherein the shaker head is in the pre-engaged condition.

FIG. 4A is a top plan view of an exemplary embodiment of the present invention with the carriage in the extended condition, wherein the shaker head has moved from the pre-engaged condition to an engaged condition.

FIG. 4B is a top perspective view of an exemplary embodiment of the present invention with the trolly system in the extended condition, wherein the shaker head has moved from the pre-engaged condition to the engaged condition.

FIG. 4C is a side elevation view of an exemplary embodiment of the present invention with the trolly system in the extended condition, wherein the shaker head has moved from the pre-engaged condition to the engaged condition.

FIG. 4D is a front elevation view of an exemplary embodiment of the present invention with the trolly system in the extended condition, wherein the shaker head has moved from the pre-engaged condition to the engaged condition.

FIG. 5A is a top plan view of an exemplary embodiment of the present invention with the trolly system in the extended condition, wherein the shaker head has moved from the engaged condition to a disengaged condition.

FIG. 5B is a top perspective view of an exemplary embodiment of the present invention with the trolly system in the extended condition, wherein the shaker head has moved from the engaged condition to the disengaged condition.

FIG. 5C is a side elevation view of an exemplary embodiment of the present invention with the trolly system in the extended condition, wherein the shaker head has moved from the engaged condition to the disengaged condition.

FIG. 5D is a front elevation view of an exemplary embodiment of the present invention with the trolly system in the extended condition, wherein the shaker head has moved from the engaged condition to the disengaged condition.

FIG. 6A is a top plan view of an exemplary embodiment of a conveyor system of the present invention.

FIG. 6B is a top perspective view of an exemplary embodiment of the conveyor system of the present invention.

FIG. 6C is a side elevation view of an exemplary embodiment of the conveyor system of the present invention.

FIG. 6D is a front elevation view of an exemplary embodiment of the conveyor system of the present invention.

FIG. 7A is a top plan view of an exemplary embodiment of a deck system of the present invention.

FIG. 7B is a top perspective view of an exemplary embodiment of the deck system of the present invention.

FIG. 7C is a side elevation view of an exemplary embodiment of the deck system of the present invention.

FIG. 7D is a front elevation view of an exemplary embodiment of the deck system of the present invention.

FIG. 8A is a top plan view of an exemplary embodiment of the conveyor and deck system working in tandem and operatively associated with a mechanized tree harvester of the present invention.

FIG. 8B is a top perspective view of an exemplary embodiment of the conveyor and deck systems working in tandem and operatively associated with the mechanized tree harvester of the present invention.

FIG. 8C is a side elevation view of an exemplary embodiment of the conveyor and deck systems working in tandem and operatively associated with the mechanized tree harvester of the present invention.

FIG. 8D is a front elevation view of an exemplary embodiment of the conveyor and deck systems working in tandem and operatively associated with the mechanized tree harvester of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

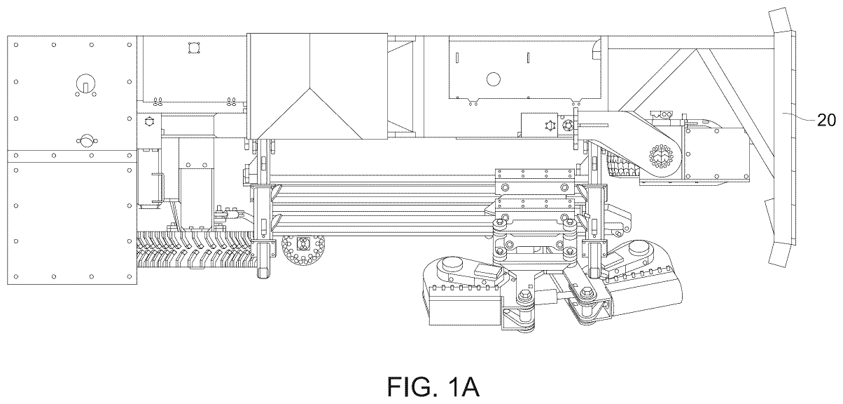

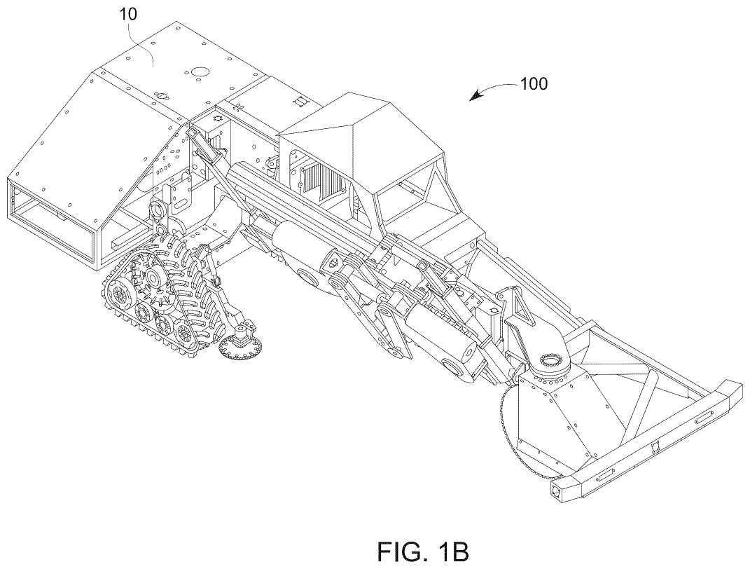

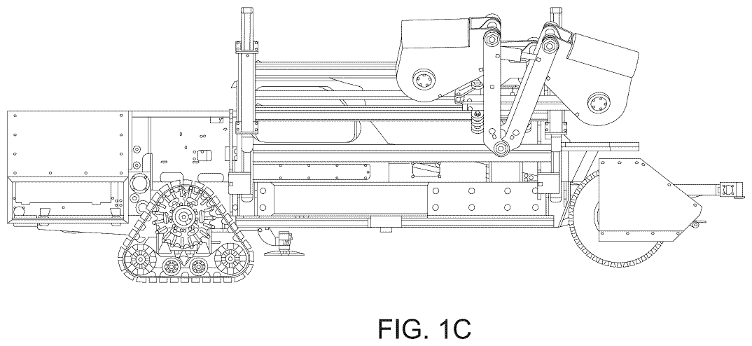

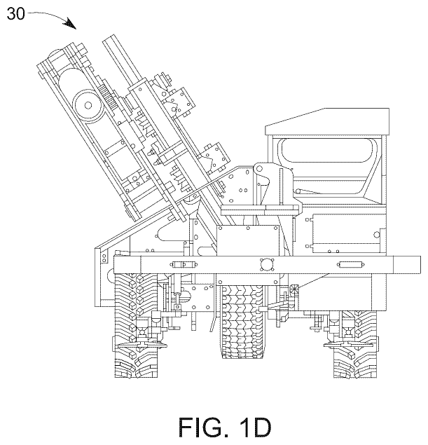

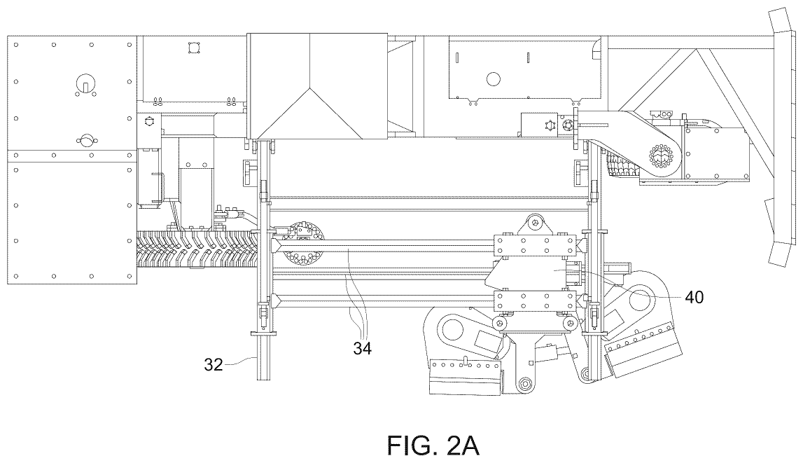

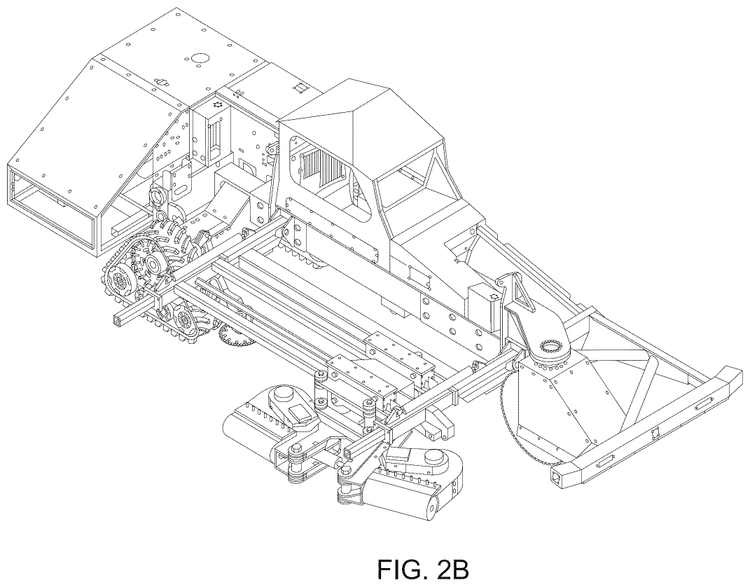

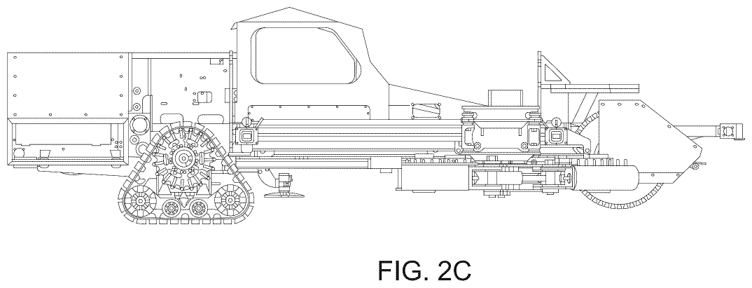

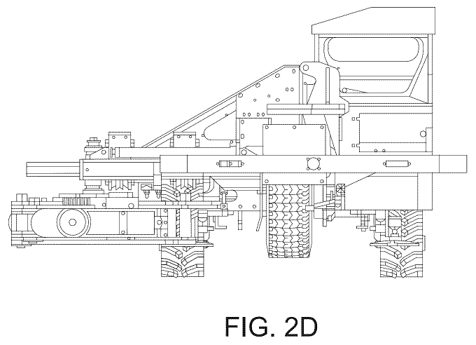

Referring now to FIGS. 1A through 5D, the present invention may include an agricultural harvester vehicle 100 having a shaker head 40 enabled to move independently of the agricultural harvester vehicle 100. The shaker head 40 may be carriage-mounted to a linear track system so that the shaker head 40 can move in a rearward direction as the agricultural harvester vehicle 100 moves in a forward direction. Accordingly, the shaker head 40 can move in an equal but opposite direction as the agricultural harvester vehicle 100 so that the shaker head moves at a zero-velocity relative to a target crop it engages and shakes while the agricultural harvester vehicle 100 continues moving forward during the entire engagement, shaking, and disengagement of the shaker head to the target tree. Thus, the agricultural harvester vehicle 100 continuously moves through an orchard shaking and harvesting a multitude of trees without having to stop or slow down at each tree. Either or both for the agricultural harvester vehicle 100 and the shaker head 40 may be autonomously guided.

The agricultural harvester vehicle 100 has a main chassis 10 which acts as the foundation of the machine and encloses a drive engine. Spaced apart from a front portion of the main chassis 10 is a front camera boom/bumper section 20 which houses the sensors for a vision-based autonomous navigation system.

Pivotably connected to a side of the main chassis 10 is a trolly system 30 movable between an elevated storage/transport condition and an operative field condition for facilitating the shake-harvesting of fruit trees. The trolly system 30 may be operatively associated with the main chassis 10 to vertically adjust the vertical elevation of the shaker head 40 relative to the supporting surface of the agricultural harvester vehicle 100.

For a frame of reference, it is understood that the forward movement or linear direction of the agricultural harvester vehicle 100 along a supporting surface is defined by a “Y” axis (y-axis). The lateral direction, parallel to the supporting surface, defined by an “X” axis (x-axis) that is perpendicular to the y-axis, and a vertical direction away from the supporting surface being along a “Z” axis (z-axis) defined perpendicular to the x-axis and y-axis.

The trolly system 30 is movably mounted upon outwardly projecting support actuators 32, wherein the support actuators 32 are oriented upwardly in the transport condition, as illustrated in FIGS. 1A through 1D, and oriented horizontally/laterally (parallel with the support surface of the agricultural harvester vehicle 100) in the field condition. The support actuators 32 of the trolly system 30 carry a linear track system 34 so that the linear track system 34 is telescopically movable between a retracted position and an extended position to further facilitate shake-harvesting of fruit trees. When the trolly system 30 is in the field condition, the tracks of the linear track system 34 are oriented in the y-axis, linear direction.

The carriage-mounted shaker head 40 is operatively associated with the linear track system 34 so that shake head 40 can move linearly along a head path that is adjacent to and parallel with a vehicular path associated with the linear forward movement of the agricultural harvester vehicle 100 along the y-axis. Advantageously, the shaker head 40 can independently move along the head path in the same or direct opposite direction of the agricultural harvester vehicle 100. Thus, the shaker head 40 can selectively control its linear, y-axis velocity relative to the agricultural harvester vehicle 100. Critically, the shaker head 40 can move along the linear track system 34 in the opposite direction as the agricultural harvester vehicle 100 so that the relative velocity of the shaker head 40 is approximately zero or approximately near zero relative to the tree being shaken by the shaker head, while the agricultural harvester vehicle 100 continues forward at a path rate, a velocity of up to five or more miles per hour, for a shaking distance approximately as long as the linear track system 34, which could be up to twenty feet or longer in length.

The shaker head 40 can selectively move along the linear track system 34 at a track rate that is independent of the path rate of the agricultural harvester vehicle 100. As a result, the agricultural harvester vehicle 100 may move linearly forward—in a positive linear y-direction—at a rate of, say, two miles per hours, while the shake head can simultaneously and independently move in the negative x-direction at two miles per hour, thereby exhibiting a zero relative linear velocity (relative to the tree crop the shaker head engages), thereby enabling the shaker head to engage and shake a tree for at least one or more seconds as the agricultural harvester vehicle 100 moves at that near constant two miles per hour without decelerating. It should be noted that a slower relative linear velocity may be exhibited through the shaker head 40 encountering resistance, such as the moment the shaker head 40 engages with a fruit tree, since the shaker head 40 is not fixed to the agricultural harvester vehicle 100 but rather free (independent of the agricultural harvester vehicle 100) to move in the negative x-direction.

The slower relative linear velocity of the shaker head 40 affords the time for the shaker head 40 to engage a tree, sufficiently shake the tree, and disengage the tree while the agricultural harvester vehicle 100 moves at a continuous path rate during the harvesting/shaking process, thereby eliminating the need for the agricultural harvester vehicle 100 to stop during the shaking process.

The shaker head 40 has a trailing clamp arm 42 and a leading clamp arm 44 that independently rotate relative to each other about the z-axis. Both clamp arms 42 and 44 are rotatably coupled to the carriage body 46 that rides along the linear track 34 of the trolly system 30. The linear track 34 of the trolly system 30 may provide rollers that are engaged by the carriage body 46, or any other structure to facilitate the sliding association of the carriage body 46 relative to the carriage body 46. Each clamp arm 42 and 44 is selectively rotatable between an engagement position and a disengagement position out of the path of an oncoming tree. When both the trailing clamp and leading clamp arms 42 and 44 are in their engagement positions about opposing sides of a tree, the shaker head 40 is deemed in an engaged condition, in the engaged condition the tree can be properly shaken by the shaker head 40 because of the vibratory and oscillating motion that the carriage body 46 can impart to the clamp arms 42 and 44.

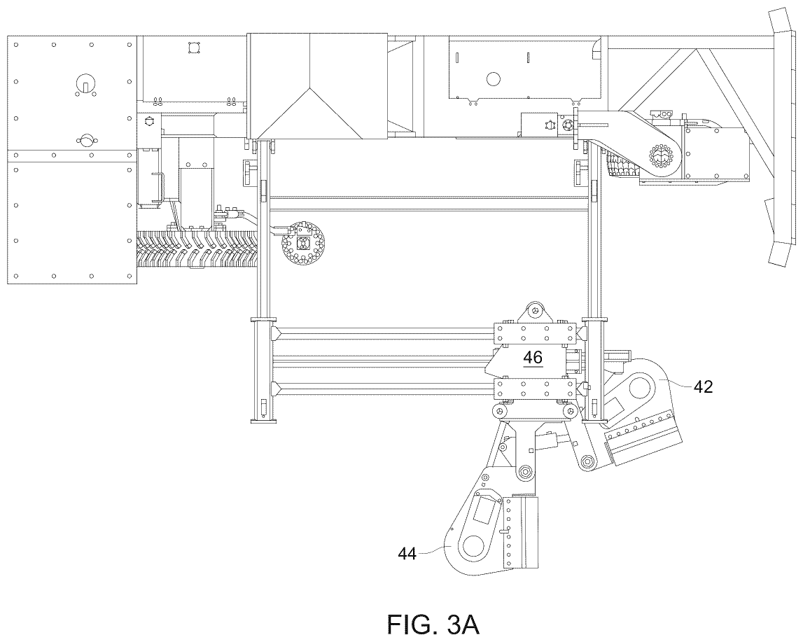

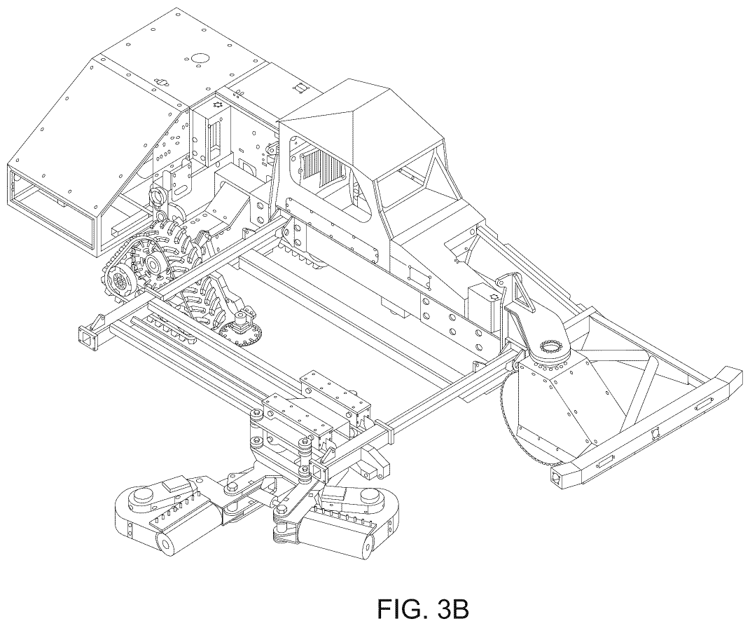

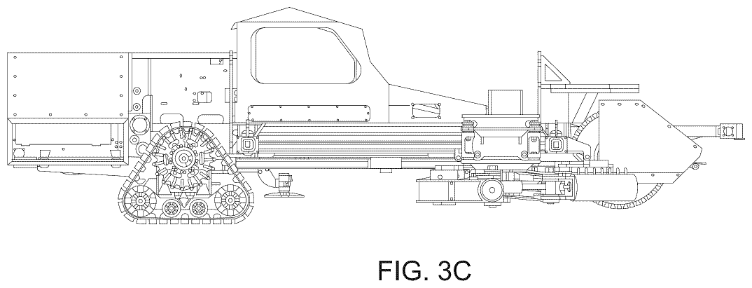

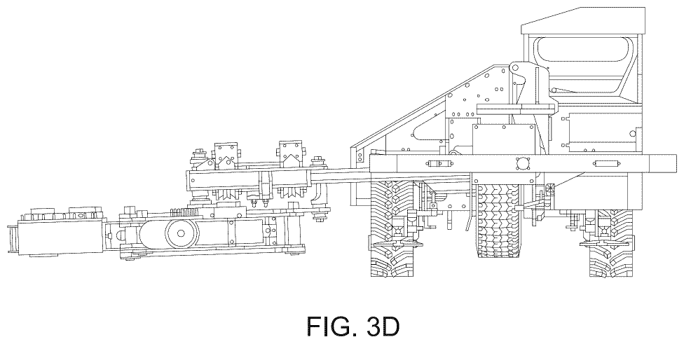

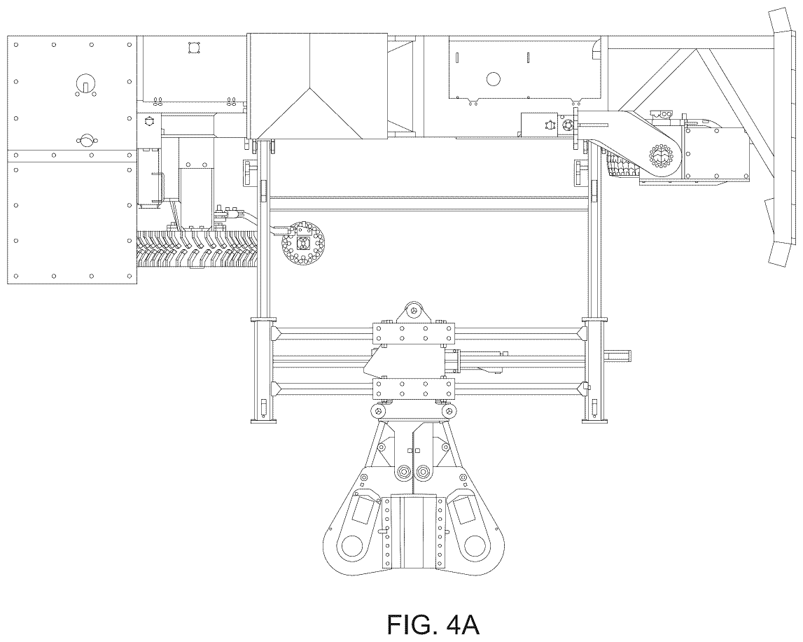

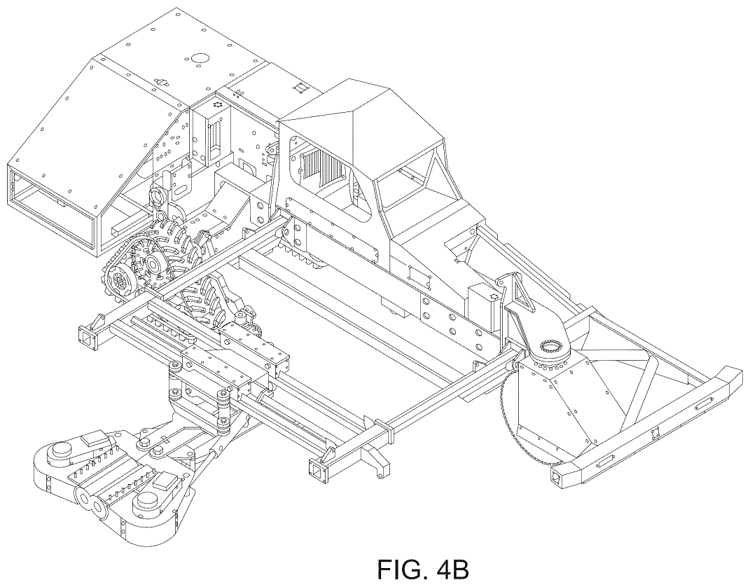

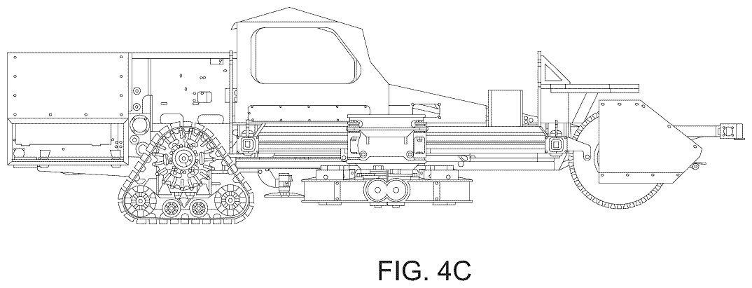

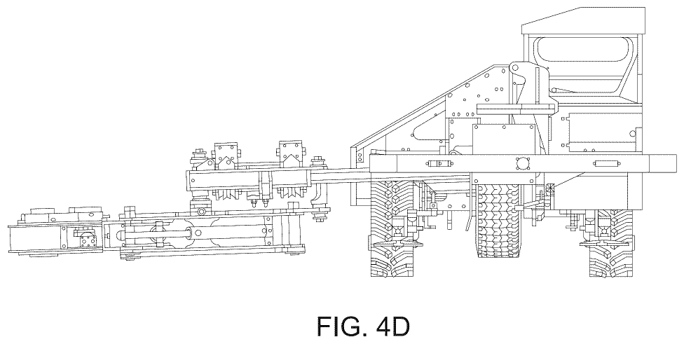

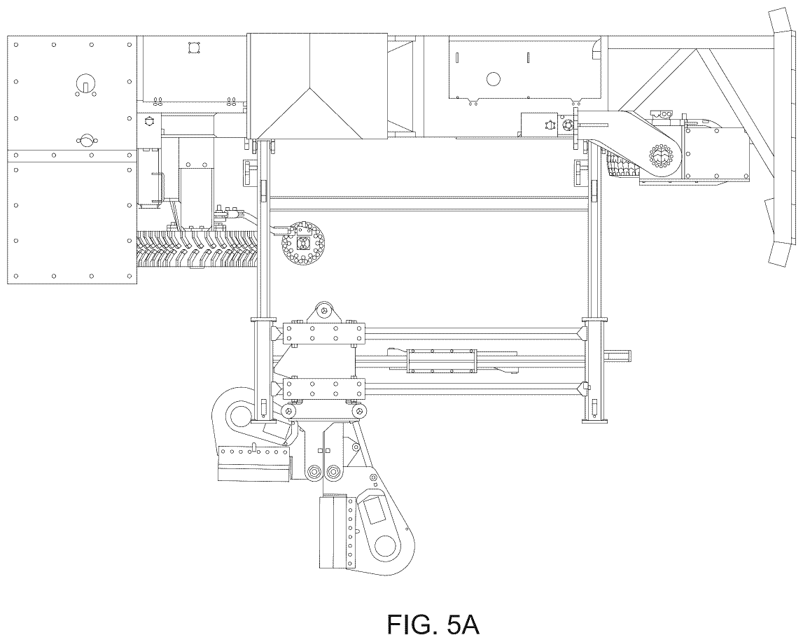

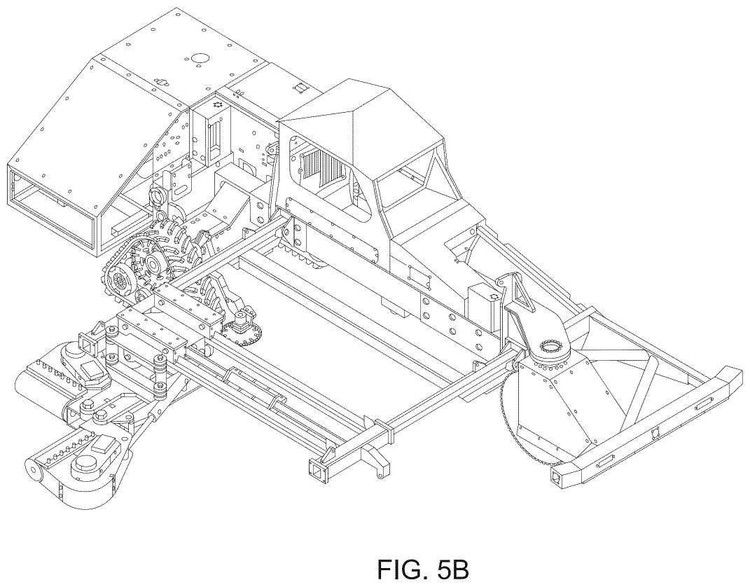

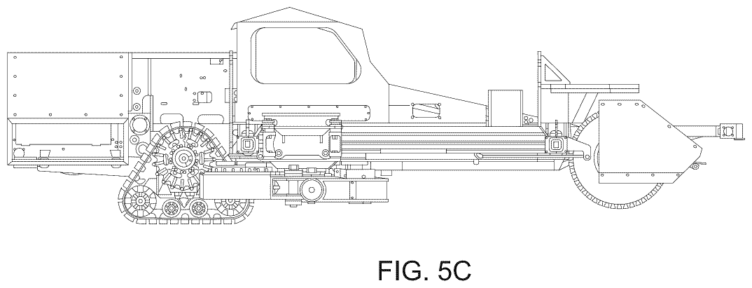

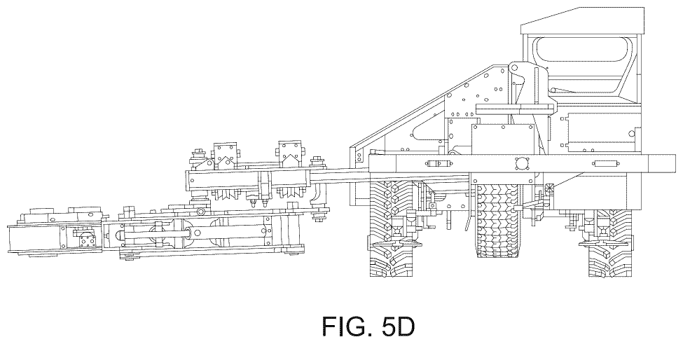

Accordingly, as harvester vehicle 100 approaches a target tree (moving in the positive y-direction), the shaker head 40 may be in a forwardmost position along the linear track system 34 with the trailing clamp arm 42 is in the engagement portion/position and the leading clamp arm 44 in the disengagement position, as illustrated in the FIGS. 3A and 3B. In such pre-engaged condition, the leading clamp arm 44 makes initial contact with the target tree, against its bumper 43, whereby the shaker head 40 starts its rearward relative linear motion (relative to the harvester vehicle 100 yet stationary relative to the target tree) along the linear track system 34. During this rearward relative linear motion, the trailing clamp arm 42 moves to the engagement position so that both clamp arms 42 and 44 engage the trunk of the target tree, thereby forming the engaged condition, as shown in FIG. 4A. In the engaged condition, the shaker head 40 utilizes the electro-hydraulic system to clamp onto trees and transmit asymmetric radial forces to remove tree crops. Then, with the shaker head approaching the rearmost portion/position of the linear track system 34, the leading clamp arm 44 rotates to the disengagement position before the shaker head 40 reaches the rearmost portion/position of the linear track system 34, thereby forming the disengaged condition, as illustrated in FIG. 5A, and completing the shaking process. Then the carriage-mounted shaker head 40 independently and automatically moves along the linear track system 34 back to the forwardmost portion/position, in the pre-engaged condition, at which it resets the clamp arms for the next re-shake.

The machine transitions from transport to field position via hydraulic actuators controlled by the operator. The movement of the clamp arms 42, 44 and the shaker head 40 on the linear track system 34 is controlled either by the operator manually, or automatically through an engaged auto control setting which systematically moves the shaker head 40 through the shake process. Once this “auto” mode is engaged, carriage body 46 moves to the forwardmost position of the trolly system 30, the trailing clamp arm 42 opens to its full disengagement position and the leading clamp arm 44 moves to the full engagement position. The harvester vehicle 100 then begins propelling forward toward the leading trunk in a row of trees. The shaker head 40 sits idle in a float position awaiting tree contact. As the trunk of a tree contacts the bumper 43 of the trailing clamp arm, the carriage body 46 and shaker head assembly remain stationary relative to the tree.

As the machine propels forward the shaker head 40 and carriage body 46 move rearward with respect to the forward moving main chassis 10. The relative displacement of carriage body 46 relative to the main chassis 10 is noted by a position sensor which initiates the movement of the leading clamp arm 42 from its disengagement position to the engagement position, immediately followed by the shaking action. The position sensor determines the position of the shaker head 40 along the trolley system 30. The position sensor may be a rotary encoder or the like that is operatively associated with the drive chain of the carriage body 46, whereby the rotary encoder can convert the angular position or motion thereof to analog or digital output signals from which linear dimensions can be calculated. Accordingly, the rotary encoder can determine the vertical z-axis elevation and lateral x-axis of the carriage body 46 and/or shaker head 40, which in turn can be used to selectively control the closing speed of the clamp arms 42 and 44 moving from a disengaged position to an engaged position, thereby preventing damage to the tree. Specifically, the position of the shaker head 40 can be adjusted if, for example, an autonomous vision system detects that a tree is leaning; wherein, the z-directional position of the shaker head 40 can be adjusted to secure a more optimal engaged condition with the tree for more optimal shaking of the tree.

When the carriage 46 nears the rearmost position, the position sensor/switch, which identifies the position of the carriage body 46 along the linear track 34, initiates the rotation of the trailing clamp arm 44 to its disengagement position, thus allowing the trunk of the tree to pass clear of the head assembly. Once the tree clears, the head and carriage body return to the forwardmost position of the linear track/trolley system and resets for the next tree. An encoder may be associated with the shaker head 40 so that a dynamic closure may be realized when the shaker head 40 transitions from the pre-engaged condition to the engaged condition.

In effect, the shaker head 40 becomes ‘fixed’ to the tree in the engaged condition, and thus the ground speed of the machine is what dictates the speed at which the head moves from the forwardmost position (pre-engaged condition) to rear position (disengaged condition).

The shaker head 40 may utilize two asymmetric flywheels which are powered by two independent hydraulic motors respectively (i.e., the two hydraulic motors are not tied together and run at different speeds relative to each other). One flywheel may be positioned in each clamp arm 42, 44. The weight, speed and direction of each flywheel can be varied thus creating customized shake patterns.

In sum, the slidable association between carriage 46 and the linear track system 34 allows for dynamic movement of the carriage-attached shaker head 40 relative to the chassis as the shaker head 40 travels from tree to tree while the chassis propels the harvester 100 through the orchard at a constant velocity. The movement of the shaker head and the constant speed of the chassis reduces the time spent by current harvesters accelerating and decelerating from tree to tree.

The harvester vehicle 100 may be operated autonomously and utilize one of a variety of autonomous systems, primarily vision-based artificial intelligence (AI) which is incorporated into the machine's electro-hydraulic control system to autonomously propel the machine through an orchard. The AI system utilizes monocular and stereo cameras to localize the machine in real space. The system also utilizes additional advanced sensing technologies including but not limited to global positioning, optical imaging, radar and laser-based scanning. The overall job of the vision stack is to map an orchard in real time while interfacing with the control system to propel the machine through the orchard on the desired vehicular path between rows of trees. The AI system may have integrated protocols and logic to allow for decision making and learning. The training process for the AI is unique in that it is specifically targeting nut bearing trees in high dust where there is frequently unreliable GPS and internet connectivity.

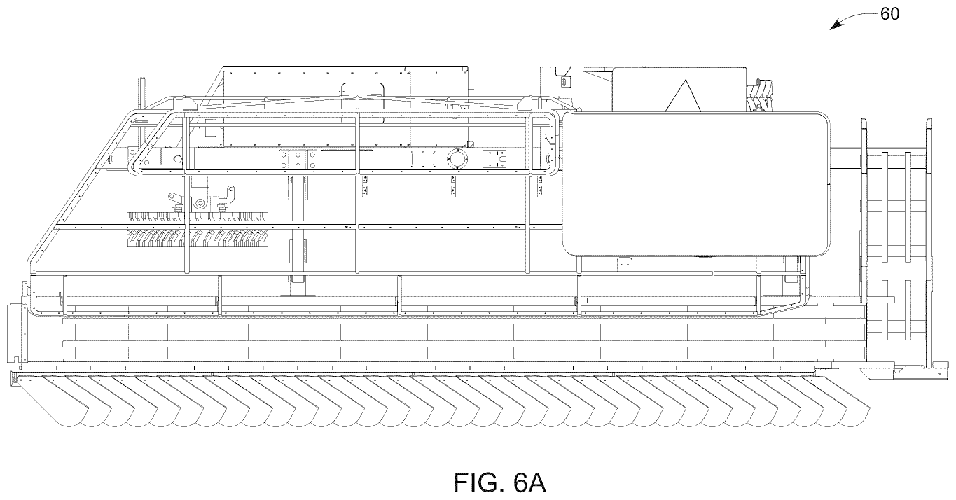

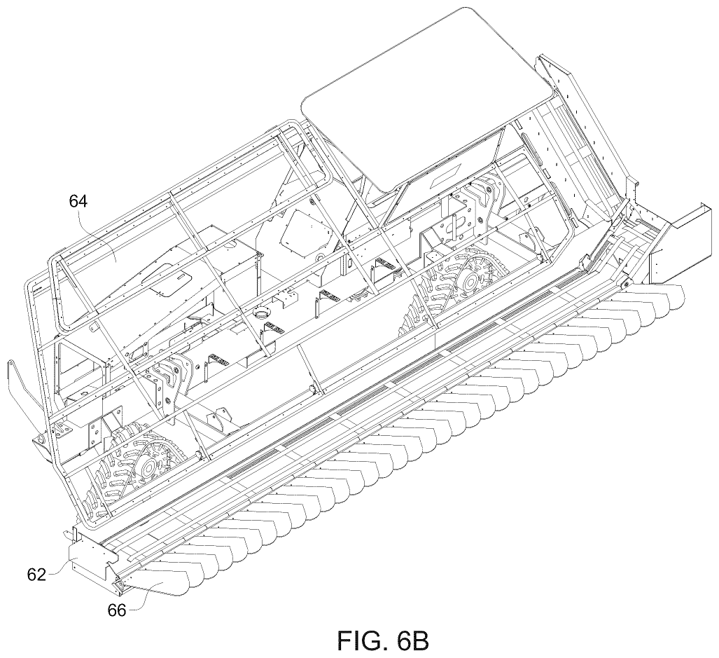

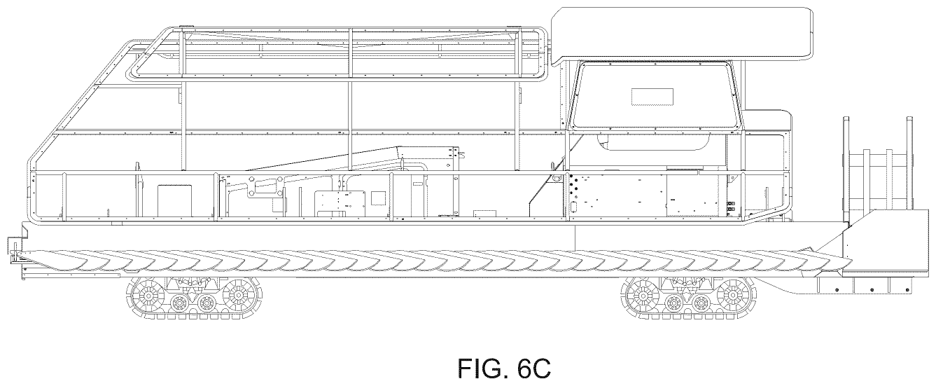

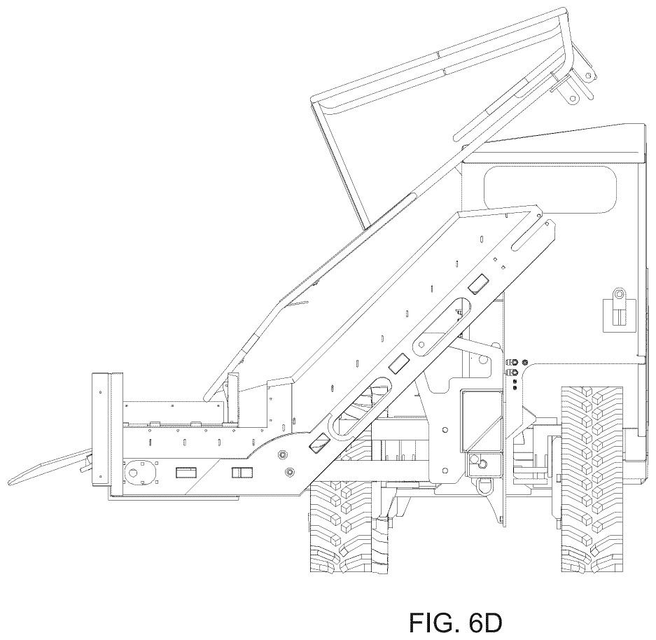

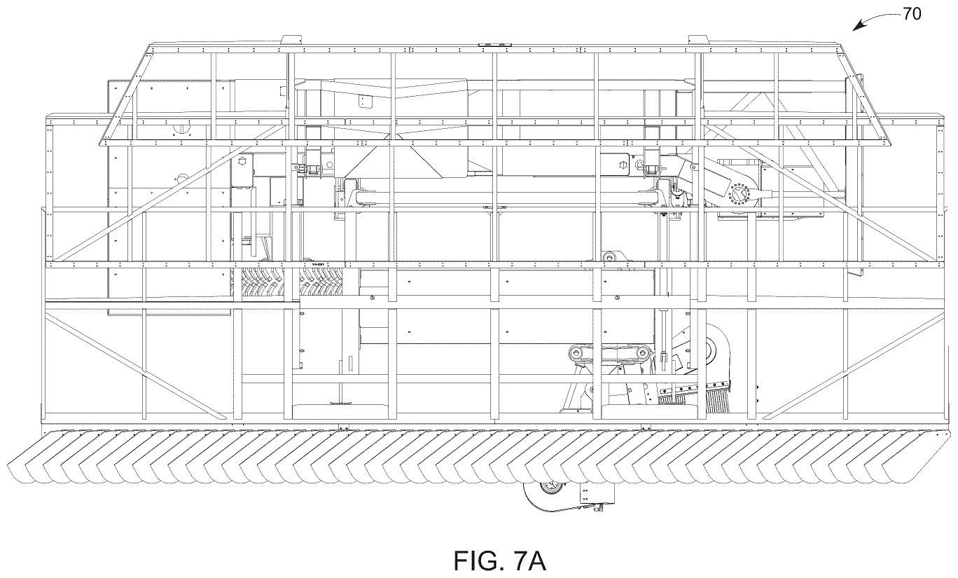

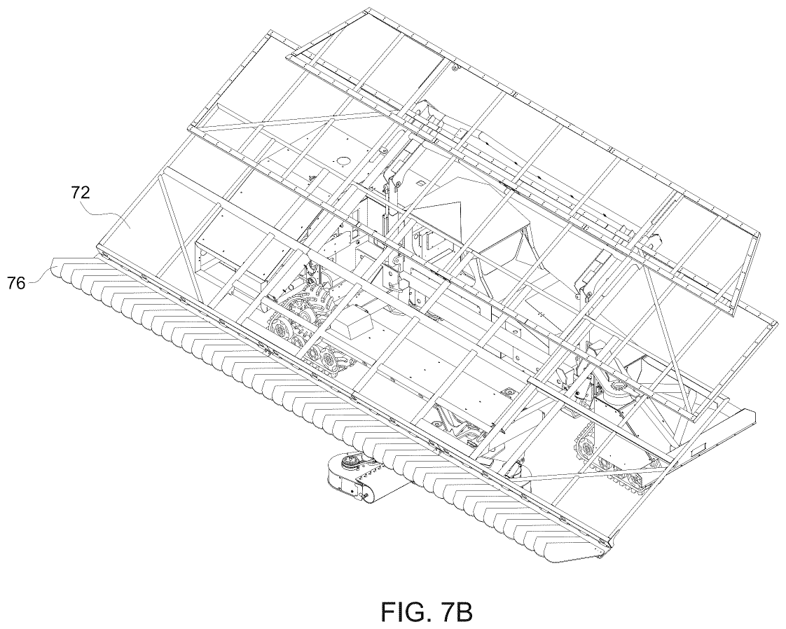

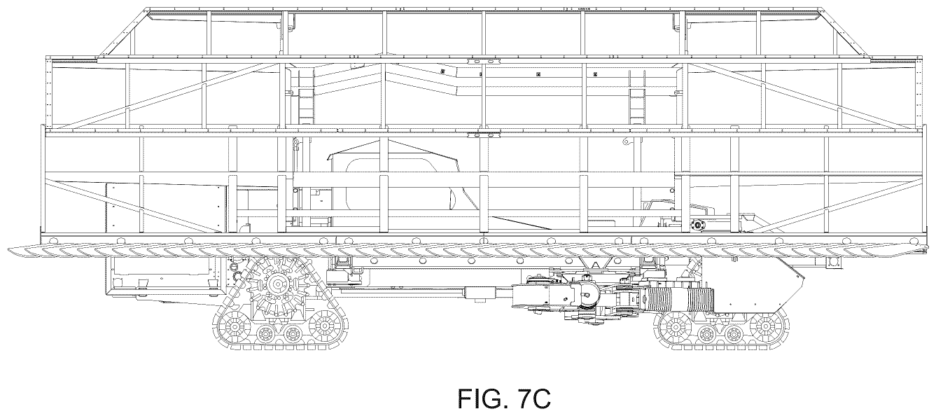

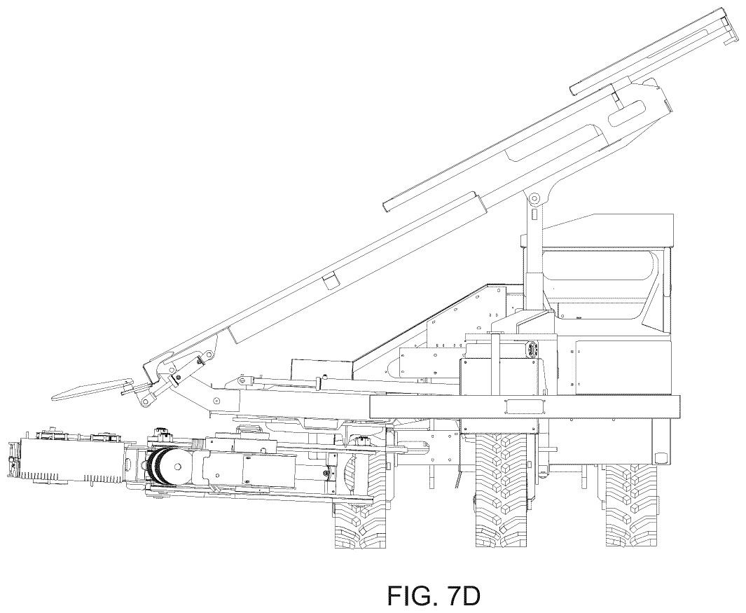

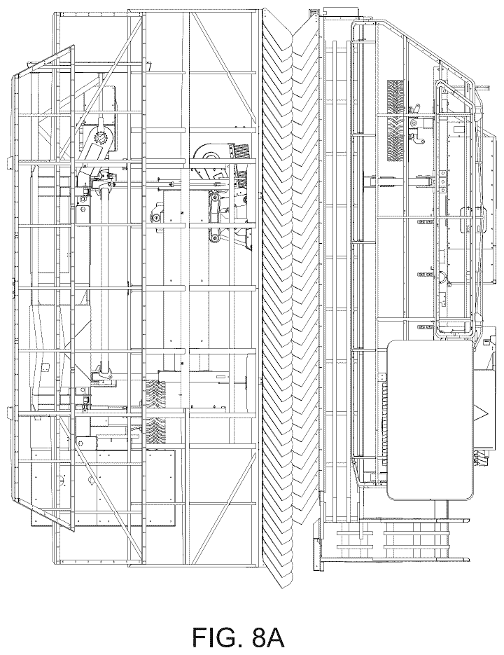

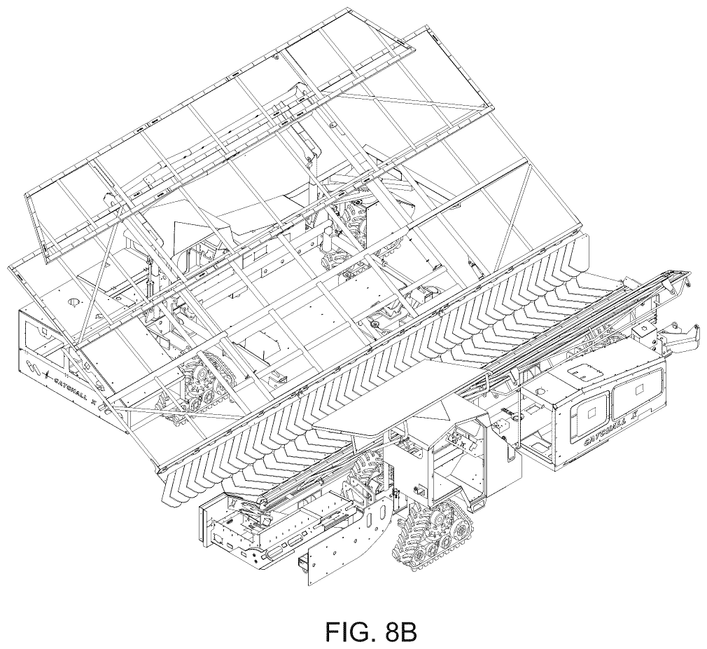

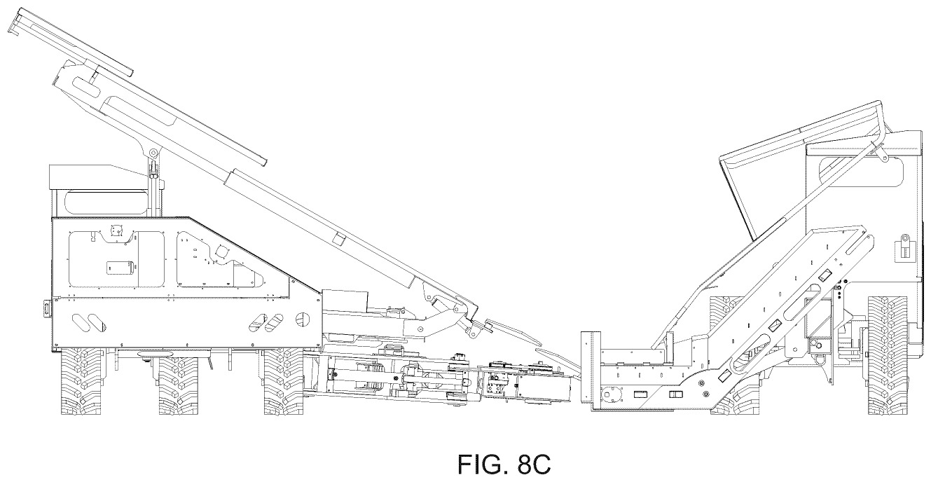

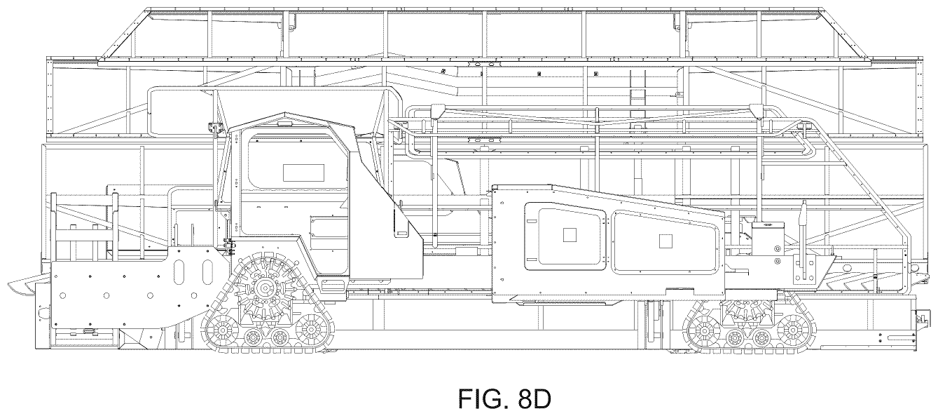

Referring now to FIGS. 6A through 8D, the present invention may include an independent conveyor system 60 and a deck system 70 that work in concert, on opposite sides of each target tree, to catch crop as it falls from the shaken tree and moves it to a larger storage bin located on the conveyor system 60. The conveyor system 60 has a drive mechanism for automatically advancing the conveyor system 60 to mirror the harvester 100 along a first direction relative to the tree line. The conveyor system 60 provides a retractable conveyor mounted to and extending from the drive mechanism towards the tree, so that a conveyor belt can be positioned adjacent to the tree truck under the branches to catch and move crops falling from the tree. An inclined deck 64 extends upwardly from a proximal edge of the conveyor belt so that fruit that falls on the inclined deck rolls to the conveyor belt 62.

The deck system 70 mounts to the agricultural tree harvester 100 to provide an inclined surface 72 between the agricultural tree harvester 100 and the branches of the fruit tree, so that while the shaker head shakes the tree the fruit contacts the inclined surface 72 directed toward the conveyor belt 62 of the driven conveyor system 60 on the other side of the tree. The deck system 70 may be mounted so that its lowest elevation is spaced apart upwardly of the trolley system 30 and shaker head 30 of the harvester 100. The deck system 70 employs a rotary ‘finger’ to transfer product to the opposite side at the rear of the deck.

Along the distal end of both the conveyor system 60 and the deck system 70 includes a plurality of overlapping pivot plates 66 and 76, respectively. Overlapping in that the leading edge of each of the pivot plates are positioned above or beneath a trailing edge of an adjacent pivot plate such that no gap exists between any two adjacent pivot plates. The overlapping pivot plates 66, 76 extend from the distal end of their respective systems 60, 70 and are arranged to accommodate a desired fruit as both the harvester 100 and the driven conveyor system 60 advance in tandem in a first direction. The pivot plates are configured to cooperate to conform to the contour of the opposing pivot plates and any intervening object, such as the target tree, thereby forming a seal between the harvester 100, the conveyor system 60, and the object/tree.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the claims.

What is claimed is:

1. A shaker mechanism for an agricultural harvester, the shaker mechanism comprising:
the shaker mechanism configured to shake a crop, wherein the shaker mechanism is operatively associated with the agricultural harvester so that the shaker mechanism is movable at zero velocity relative to the crop being shook while the agricultural harvester continuously moves at a non-zero velocity.

2. The shaker mechanism of claim 1, wherein the shaker head is movable at said zero velocity while the agricultural harvester is moving at the non-zero velocity for at least five feet.

3. The shaker mechanism of claim 1, wherein the shaker mechanism comprises a carriage body slidable along the linear track system.

4. The shaker mechanism of claim 3, wherein the shaker mechanism further comprises a leading clamp arm and a trailing clamp arm, each clamp arm independently pivotably relative to the carriage body to move between a disengaged position and an engaged position that places the clamp arm in a path of the crop.

5. The shaker mechanism of claim 4, wherein the shaker mechanism, immediately before shaking the crop, is located at a forwardmost position along the linear track system with the leading clamp arm in the engaged position and the trailing clamp arm in the disengaged position.

6. The shaker mechanism of claim 5, wherein the shaker mechanism is shaking the crop with both clamp arms in the engaged position.

7. The shaker mechanism of claim 6, wherein when the shaker mechanism is located at a rearmost position along the linear track system the leading clamp arm is in the disengaged position off the path of the crop.

8. The shaker mechanism of claim 7, wherein the linear track system is pivotably connected to the agricultural harvester.

9. A system comprising:
an agricultural harvester; and
a shaker mechanism configured for shaking a crop while the agricultural harvester moves in a first linear direction, wherein the shaker mechanism is operatively associated with the agricultural harvester so that the shaker mechanism is movable in a second linear direction opposite the first linear direction while shaking the crop as the agricultural harvester moves in the first linear direction.

10. The system of claim 9, wherein the agricultural harvester moves along a harvester path and the shaker mechanism moves along a shaker path defined by a linear track system, wherein the harvester path and the shaker path are parallel.

11. The system of claim 10, wherein the shaker mechanism comprises a carriage body slidable along the linear track system.

12. The system of claim 11, wherein the shaker mechanism further comprises a leading clamp arm and a trailing clamp arm, each clamp arm independently pivotably relative to the carriage body to move between a disengaged position and an engaged position that places the clamp arm in a path of the crop.

13. The system of claim 12, wherein the shaker mechanism, immediately before shaking the crop, is located at a forwardmost position along the linear track system with the leading clamp arm in the engaged position and the trailing clamp arm in the disengaged position.

14. The system of claim 13, wherein the shaker mechanism is shaking the crop with both clamp arms in the engaged position.

15. The system of claim 14, wherein when the shaker mechanism is located at a rearmost position along the linear track system the leading clamp arm is in the disengaged position off the path of the crop.

16. The system of claim 15, wherein the linear track system is pivotably connected to the agricultural harvester.
